(19) United States
(12) Patent Application Publication
(10) Pub. No.: US 2023/0202617 A1
(43) Pub. Date: Jun. 29, 2023

(54) Bicycle Seat Force Sensor

(71) Applicant: Hazem Nihad Hamed, Los Angeles, CA (US)

(72) Inventor: Hazem Nihad Hamed, Los Angeles, CA (US)

(21) Appl. No.: 18/109,704

(22) Filed: Feb. 14, 2023

(51) Int. Cl. B62M 6/50

(52) U.S. Cl. CPC B62M 6/50

(57) ABSTRACT

A force sensor for a seat of a bicycle providing in real time measurements of exerted force by a rider against a bicycle pedals through diminished force exerted thereof by the rider against the bicycle seat and additionally entailing approximate crank angle of the pedals through further analysis as the measured seat force typically consists of an alternating profile where the force is maximum when the pedals are in a horizontal position and minimum while the pedals are vertical.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

The disclosed invention relates to the cycling transportation and sporting industry, specifically to modern bicycle designs typically making use of front and rear powered drive chain derailleurs serving to alternate drive chain position between different ratio front and rear drive sprockets through wiring to a set of rider control switches, thereby permitting the rider to achieve an optimal drivetrain ratio through selection of an adequate combination of front and rear drive sprockets, thereby facilitating a comfortable pedaling rate and effort thereof depending on desired road speed, rider conditioning, road inclination and other circumstantial conditions.

### BACKGROUND OF THE INVENTION

Bicycles have existed for many years serving throughout as transportation and sporting means. Over the great time span since their inception, the technology has evolved with numerous designs and advancements predominantly geared toward addressing rider comfort. With the initial designs from many years ago comprising a single speed power transmission mechanism often requiring the rider to either exert undue effort on the pedals or have to alternate the pedals at an uncomfortably high rate to achieve desired riding speed, a need was recognized for multiple powertrain ratios to facilitate acceptable operator pedaling rates and efforts. A variety of designs consequently emerged where additional power transmission sprockets of various number of teeth but equal pitch were added in the axial directions of the pedals mechanism as well as power transmission rear wheel to facilitate a combination of front and rear power transmission ratios resulting in optimal settings based on desired bicycle speeds, road conditions, operator biometrics and preference. This innovation was facilitated by the de-facto standard four bar linkage mechanism based derailleur assembly used to this very day to alternate drive sprockets through properly positioning the drive chain thereto as well as compensate for resultant varying chain lengths through an integral spring loaded chain tensioning mechanism. The capability was facilitated by two cable tensioning apparatuses, one for rear sprockets and another for the fronts. With one end of each cable apparatus connected to the derailleur chain positioning mechanism and the other end to an operator actuation mechanism typically comprising a lever assembly, this apparatus granted the operator the ability to adjust the chain position in the axial direction for proper alignment and thereby engagement of selected rear and front drive sprockets in order to achieve optimal power transmission ratio settings. Advancements in the actuation mechanism included indexing capability of the operator lever assembly so that the actuation of the gearing mechanism takes place in an indexing fashion consistently properly aligning the chain with desired sprocket thereof rather than one continuous motion requiring the operator to guess the proper chain position often leading to positioning errors.

Most recent developments stemming from desire to eliminate shifting cables altogether and additionally relieve operator actuation efforts through replacement of the shifter mechanisms with switching devices, resulted in a number of powered derailleur designs making use of small DC motors acting through typically a worm and spur gearset to drive the derailleur mechanisms through actuation of one of the joints of their four bar linkages, equally applicable to both rear as well as front derailleurs.

Further advancement in the technology included controls for monitoring of operator expended efforts throughout their riding experiences by pedaling effort sensors and heart rate monitors, integrated thereof into shifting controls by wireless communication means such as WiFi and Bluetooth, permitted recordation of operator riding behaviors for subsequent analysis.

### DISCUSSION OF PRIOR ART

The following is a brief summary of prior art deemed pertinent to the bicycle seat force sensor of the present invention.

U.S. Pat. No. 9,097,598 B2 discloses a torque sensor mounted to a tubular member serving to interconnect crank members or a bicycle pedals is equipped with a coupled strain gauges mounted on a forty-five-degree helical angle to member axis thereof serving to measure torsional deflection and thereby exerted torque on the pedals. Notwithstanding ability to measure exerted torque, this apparatus has no inherent temperature compensation as both strain gauges are subject to similar elongation and contraction based on their position.

U.S. Pat. No. 8,387,470 B2 discloses a bicycle crank extension serving as a pedal mount comprising three strain gauges mounted on 60 degree angles intended to measure exerted pedal force. Although this design measures pedal exerted force through sensing of deformation of the pedal mount, it achieves that objective through additional complexity and weight from intricate member requiring substantial machining.

U.S. Pat. No. 8,117,923 B2 discloses a bicycle pedals assembly auxiliary flange comprising two attached overlapping strain gauges serving to measure pedals torque through sensing of elastic deformation. With this highly intricate design suffering from complexity, it additionally requires use of a wireless transmission unit as the strain gauges are mounted on a rotating member.

Notwithstanding the extensive endeavor in the art, a standard high efficiency front derailleur actuator apparatus entailing additional highly desirable characteristics such as built-in overload protection, minimal weight and a fast response time remains elusive.

### BRIEF SUMMARY OF THE INVENTION

Applicant hereby discloses three wireless and wired bicycle control schemes permitting semi-automatic and fully automatic control of bicycle shifting, through wired and wireless communication to front and rear derailleurs, based on sensors monitoring bicycle speed, road inclination, wind loads, operator mass and effort through a newly disclosed seat force sensor.

In a first control scheme, a rider makes use of a touchscreen based device such as a cellphone to wirelessly monitor using Bluetooth low energy (BLE) status of front and rear derailleur actuation switches, bicycle speed sensor and wind load sensor, and additionally monitor through a Bluetooth wireless connection road inclination, vertical and forward bicycle acceleration as relayed by a shifter control unit directly wired to front derailleur, rear derailleur, chain movement sensor and a newly disclosed seat force sensor, compiles all received inputs through an application program (App) running on the touchscreen based device, and finally commands Bluetooth wireless shifter control unit to conduct resultant shifting actions based on manual and pre-programmed operator invoked semi-automatic and fully automatic control modes.

In a second and third control schemes, a rider makes use of a touchscreen based device such as a cellphone to wirelessly monitor using Bluetooth low energy (BLE) status of front and rear derailleur actuation switches, bicycle speed sensor, wind load sensor, road inclination sensor, vertical and forward bicycle acceleration sensors, and a seat force sensor, compiles all received inputs through an application program (App) running on the touchscreen based device, and finally commands through a Bluetooth wireless connection for the second scheme and a remote control (RC) servo wireless communication for the third scheme, wireless front and rear derailleurs to conduct resultant shifting actions based on manual and pre-programmed operator invoked semi-automatic and fully automatic control modes.

A critical newly disclosed device in all three aforementioned schemes is a seat force sensor which, unlike pedaling sensors must rely on wireless communication, can be directly wired to a shifter control unit and thereby directly serving to relay operator pedaling effort for analysis and control thereof. The disclosed seat force sensor is additionally offered in three fairly close but fundamentally variant designs with each capable of being directly wired or equipped with wireless transmission means.

Additionally, with the rider exerting effort on the pedals in a non-continuous fashion, as in maximum force when the pedals are in the horizontal position doing work and minimum force when the pedals are in the vertical position where extraneous exerted force is wasted and therefore avoided, signal from the proposed preferred as well as alternate embodiments of bicycle seat force of the present invention are not direct rather alternates thereby offering ability to sense actual position of the pedals.

### BRIEF DESCRIPTION OF THE DRAWINGS

FIG. 1 is an overall view of the mechanical and electrical components of a bicycle making use of the preferred embodiment of the seat force sensor of the present invention.

FIG. 2 is a perspective view of the powertrain of a bicycle making use of the preferred embodiment of the seat force sensor of the present invention.

FIG. 3 is a perspective view of the operator command panel, hot wire anemometer and derailleur switches of a bicycle making use of the preferred embodiment of the seat force sensor of the present invention.

FIG. 4 is a block diagram of a comprehensive control system for a bicycle making use of the preferred embodiment of the seat force sensor of the present invention.

FIG. 5 is an overall view of the mechanical and electrical components a first variant of a bicycle making use of an alternate embodiment of the seat force sensor of the present invention.

FIG. 6 is a block diagram of a comprehensive control system of the first variant of a bicycle making use of the alternate embodiment of the seat force sensor of the present invention.

FIG. 7 is an overall view of the mechanical and electrical components of a second variant of a bicycle making use of the alternate embodiment of the seat force sensor of the present invention.

FIG. 8 is a block diagram of a comprehensive control system of the second variant a bicycle making use of the alternate embodiment of the seat force sensor of the present invention.

FIG. 9A is a side view of a bicycle rider applicable to each of the preferred and alternate embodiments of the seat force sensor of the present invention.

FIG. 9B is a force free body diagram of a bicycle rider applicable to each of the preferred and alternate embodiments of the seat force sensor of the present invention.

FIG. 10A is a side view of the components comprising the preferred embodiment of the seat force sensor of the present invention.

FIG. 10B is an exploded side view of the components comprising the preferred embodiment of the seat force sensor of the present invention.

FIG. 10C is an exploded side view of the force sensing cantilever beam arrangement of the preferred embodiment of the seat force sensor of the present invention.

FIG. 11A is a force free body diagram of the force sensing cantilever beam of the preferred embodiment of the seat force sensor of the present invention.

FIG. 11B is a top view of the force sensing cantilever beam of the preferred embodiment of the seat force sensor of the present invention.

FIG. 11C is an isometric view of the force sensing cantilever beam of the preferred embodiment of the seat force sensor of the present invention.

FIG. 11D is the Wheatstone Bridge interconnect diagram of the preferred embodiment of the seat force sensor of the present invention.

FIG. 12A is an isometric view of the first alternate embodiment of the seat force sensor of the present invention.

FIG. 12B is an exploded view of the first alternate embodiment of the seat force sensor of the present invention.

FIG. 12C is an isometric view of the load cell made use of by the first alternate embodiment of the seat force sensor of the present invention.

FIG. 13A is an isometric view of the bicycle seat saddle shock rail mounted strain gauge network made use of by a second alternate embodiment of the seat force sensor of the present invention.

FIG. 13B is an isometric view of the components of the second alternate embodiment of the seat force sensor of the present invention.

FIG. 13C is an isometric view of the strain gauge pairing made use of by the second alternate embodiment of the seat force sensor of the present invention.

FIG. 13D is a sectional view of the strain gauge wiring made use of by the second alternate embodiment of the seat force sensor of the present invention.

FIG. 14 is the Wheatstone Bridge interconnect diagram for seat force sensing made use of by the second alternate embodiment of the seat force sensor of the present \invention.

### DETAILED DESCRIPTION OF THE INVENTION

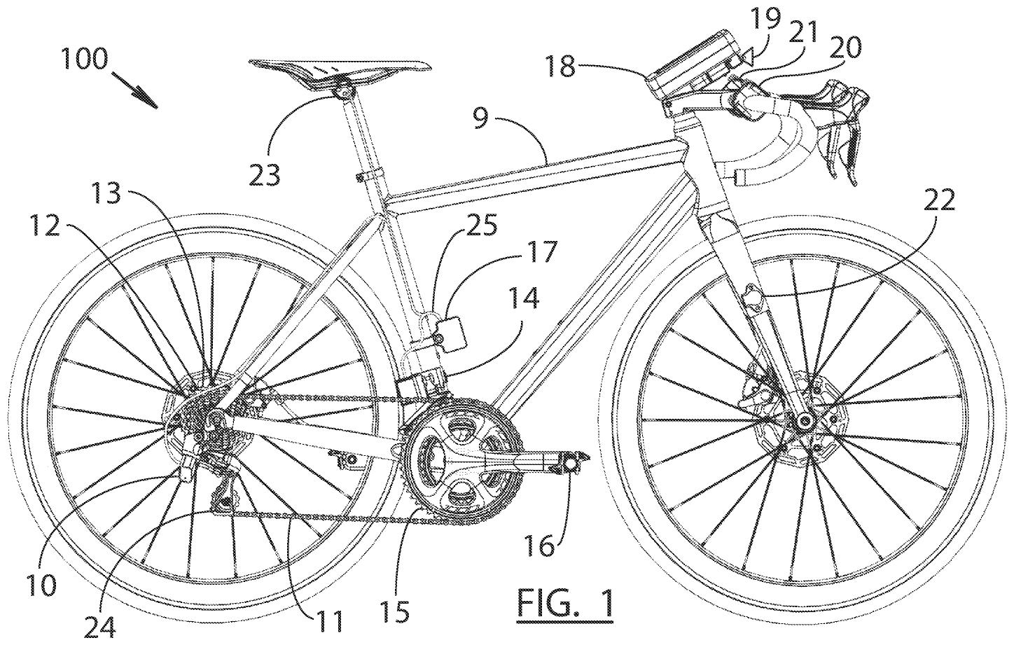

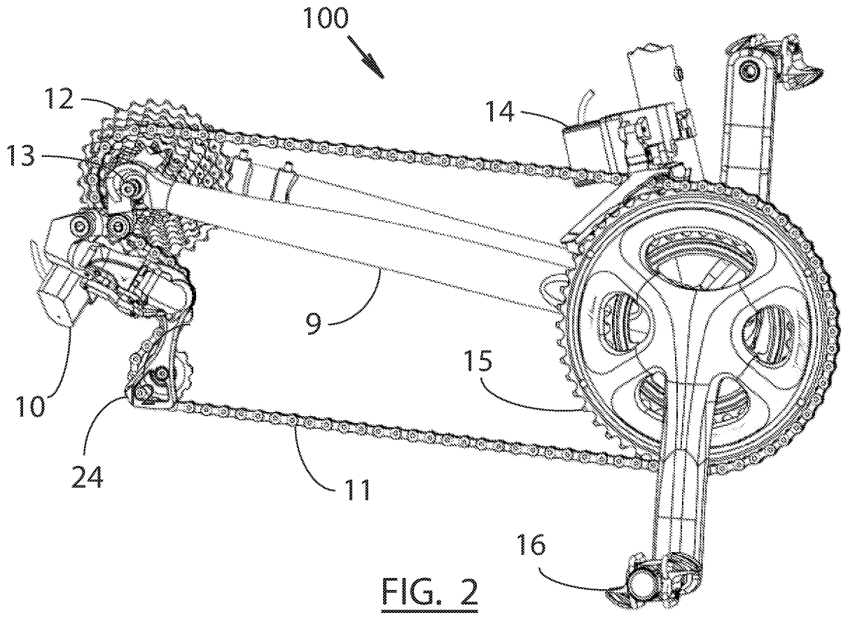

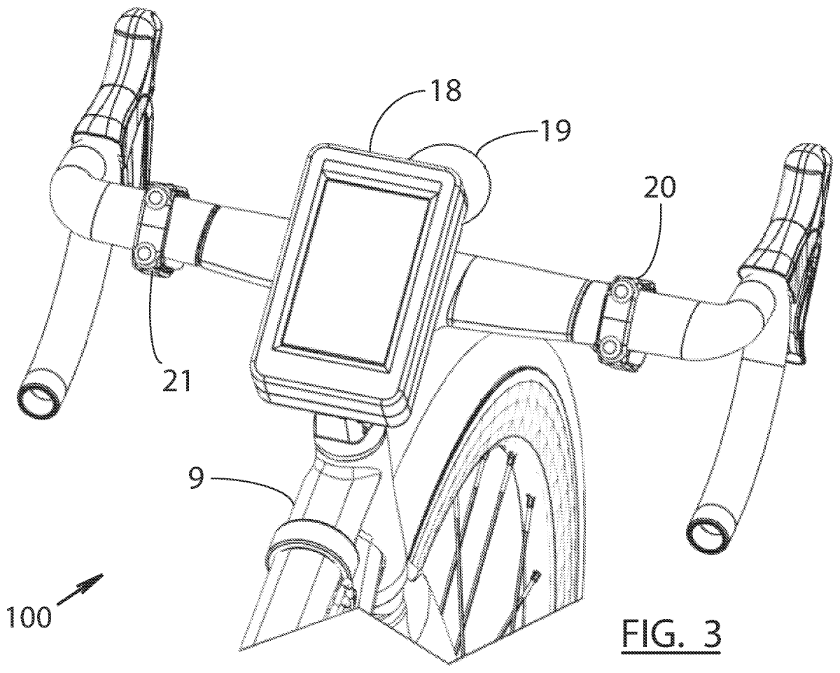

Preferred Embodiment Construction—FIGS. 1-4.

With reference to FIGS. 1-4, the preferred embodiment 100 of a bicycle making use of the preferred embodiment seat force sensor of the present invention comprises bicycle frame 9, rear derailleur 10 serving to alternate chain 11 between sprockets 12 of rear drive hub assembly 13, front derailleur 14 serving to alternate chain 11 between front sprockets assembly 15 of front pedals assembly 16, control system 17, operator command panel 18, how wire anemometer 19, rear derailleur switches 20, front derailleur switches 21, speed sensor 22, seat force sensor 23 and chain movement sensor 24. Partially shown wiring harness 25 serves to interconnect rear derailleur 10, front derailleur 14, seat force sensor 23 and chain movement sensor 25 to control system 17.

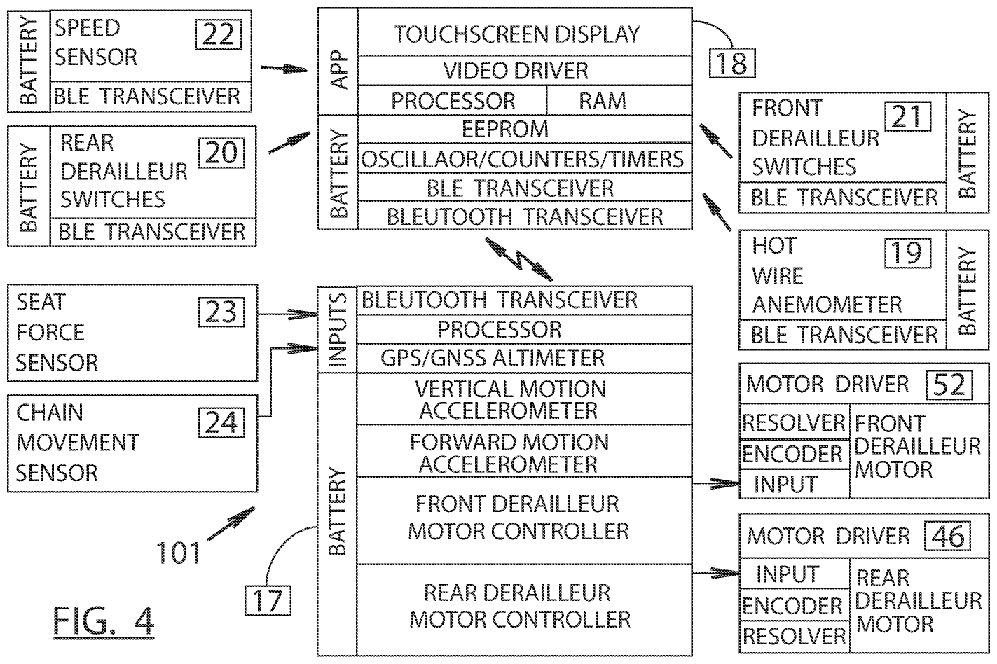

Preferred Embodiment Controls—FIG. 4.

With reference to FIG. 4, the preferred embodiment 100 of a bicycle making use of controls block diagram 101 of the preferred embodiment of the seat force sensor of the present invention includes Control system 17 comprising steady power supply rechargeable battery pack 26, GPS/GNSS altimeter 27, vertical motion accelerometer 28, forward motion accelerometer 29, input terminals 30 serving to receive readings of seat force sensor 23 and chain movement sensor 24, and processor 31 serving to relay status of chain movement sensor 24, seat force sensor 23, forward motion accelerometer 29, vertical motion accelerometer 28, GPS/GNSS altimeter 27 to operator command panel 18 through Bluetooth transceiver 32 and receive feedback and operator commands thereof in order execute control commands to front derailleur motor controller 33 and rear derailleur motor controller 34.

Operator command panel 18 comprising battery 35, touchscreen display 36, video driver 37, controls subsection 38 comprising processor 39, random access memory (RAM) 40, electrically erasable programmable read only memory (EEPROM) 41, oscillator/counters/timers subsection 42, acting as an integral system executing application program (APP) 43 serving to evaluate readings of chain motion sensor 24, seat force sensor 23, forward motion accelerometer 29, vertical motion accelerometer 28, GPS/GNSS altimeter 27, received through Bluetooth transceiver 44, and commands from rear derailleur switches 20, front derailleur switches 21, speed readings from speed sensor 22 and wind load readings from hot wire anemometer 19 received through Bluetooth Low Energy (BLE) transceiver 45, and in turn issue controls command to control system 17 for programmed energization of front derailleur motor controller 33 and rear derailleur motor controller 34 through Bluetooth transceiver 44.

Rear derailleur motor controls subsection 46 comprises input terminals 47 serving to receive power and control signal 48 from rear derailleur motor controller 34 of control system 17, comparator/resolver 49 serving to compare rear derailleur encoder signal 50 to received control signal 48 and accordingly bias motor driver 51 serving to power motor of rear derailleur 10.

Front derailleur motor controls subsection 52 comprises input terminals 53 serving to receive power and control signal 54 from front derailleur motor controller 33 of control system 17, comparator/resolver 55 serving to compare front derailleur encoder signal 56 to received control signal 54 and accordingly bias motor driver 57 serving to power motor of front derailleur 14.

Operating as individually powered standard Bluetooth Low Energy (BLE) spectrum protocol discrete transmission units, speed sensor 22, front derailleur switches 21, rear derailleur switches 20 and hot wire anemometer 19, each comprising own battery 58 for power and own Bluetooth Low Energy (BLE) transceiver 59, serve to respectively transmit bicycle speed, operator commands, and wind speed with data thereof intercepted by BLE transceiver 45 for data processing through APP 43 of operator command panel 18.

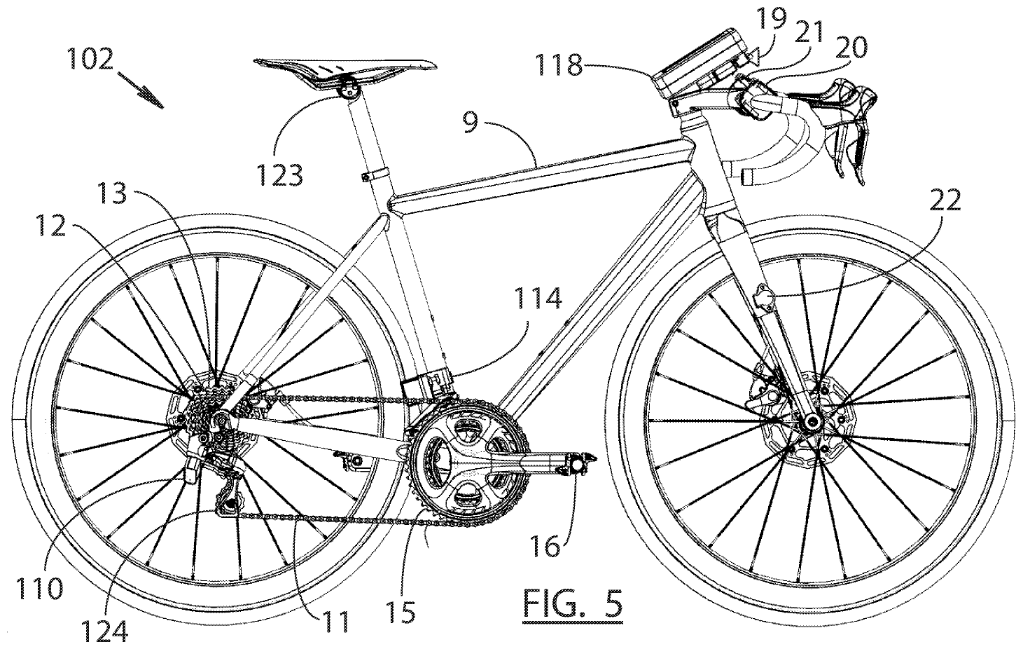

First Alternate Embodiment Construction—FIGS. 5 & 6.

With reference to FIGS. 5 & 6, the first alternate embodiment 102 of a bicycle making use of the alternate embodiment seat force sensor of the present invention comprises bicycle frame 9, rear derailleur 110 serving to alternate chain 11 between sprockets 12 of rear drive hub assembly 13, front derailleur 114 serving to alternate chain 11 between front sprockets assembly 15 of front pedals assembly 16, operator command panel 118, how wire anemometer 19, rear derailleur switches 20, front derailleur switches 21, speed sensor 22, seat force sensor 123 and chain movement sensor 124.

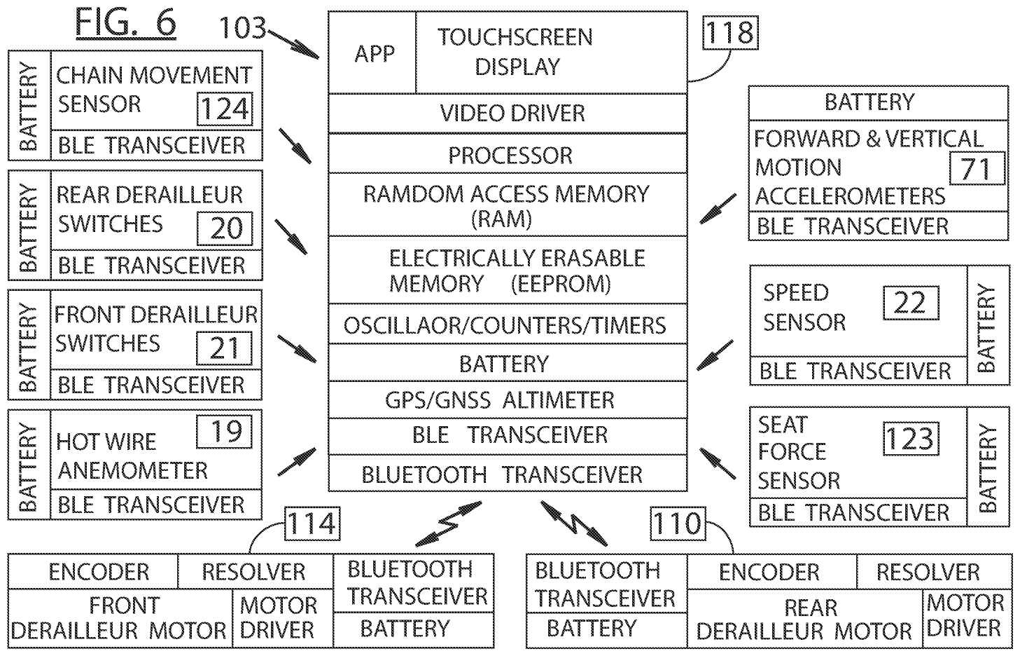

First Alternate Embodiment Controls—FIG. 6.

With reference to FIG. 6 again, the first alternate embodiment 102 of a bicycle making use of controls block diagram 103 of the alternate embodiment seat force sensor of the present invention comprising control panel 118 acting as a central wireless system controller powered by battery 60, displaying system status and receiving operator commands through touchscreen display 61 based on application program (App) 62 executing on microcontroller subsection 63 including processor 64, video driver 65, random access memory (RAM) 66, electrically erasable programmable read only memory (EEPROM) 67, oscillator/counters/timers subsection 68, based on signals received from integral GPS/GNSS Altimeter 69 and through Bluetooth Low Energy (BLE) transceiver 70 wireless signals received from speed sensor 22, front derailleur switches 21, rear derailleur switches 20, hot wire anemometer 19, seat force sensor 123, chain movement sensor 124 and forward and vertical motion accelerometers 71, serves to wirelessly command each of battery powered front derailleur 114 and battery powered rear derailleur 110 through own integral Bluetooth transceiver 72.

Operating as individually powered standard Bluetooth Low Energy (BLE) spectrum protocol discrete transmission units, chain movement sensor 124, seat force sensor 123, speed sensor 22, front derailleur switches 21, rear derailleur switches 20, hot wire anemometer 19, and forward and vertical motion accelerometers 71, each comprising own battery 73 for power and own Bluetooth Low Energy (BLE) transceiver 74, serve to transmit chain movement, seat force, bicycle speed, front and rear derailleur operator commands, wind speed, and forward and vertical accelerations respectively to operator command panel 118 intercepted through BLE transceiver 70 for data processing thereof through APP 62.

Relying on wireless Bluetooth transceiver 75 serving to relay derailleur position and receive derailleur position commands from control panel 118, front derailleur 114 additionally comprises, battery 76 serving to provide power and digital magnetic rotary encoder 77 serving to relay actual derailleur position to comparator/resolver 78 used to compare actual derailleur position thereof to desired derailleur position 79 received from control panel 118 and accordingly bias motor driver 80 serving to power electrical motor of front derailleur 114.

Relying on wireless Bluetooth transceiver 81 serving to relay derailleur position and receive derailleur position commands from control panel 118, rear derailleur 110 additionally comprises, battery 82 serving to provide power and digital magnetic encoder 83 serving to relay actual derailleur position to comparator/resolver 84 used to compare actual derailleur position thereof to desired derailleur position 85 received from control panel 118 and accordingly bias motor driver 86 serving to power electrical motor of rear derailleur 110.

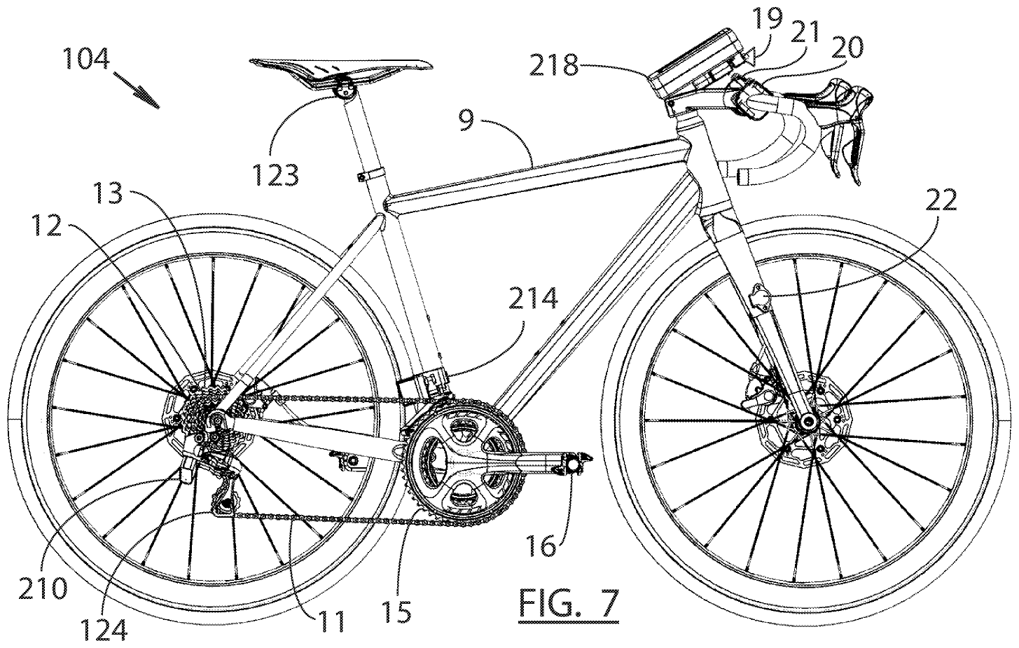

Second Alternate Embodiment Construction—FIGS. 7 & 8.

With reference to FIGS. 7 & 8, the second alternate embodiment 104 of a bicycle making use of making use of the alternate embodiment seat force sensor of the present invention comprises rear derailleur 210 serving to alternate chain 11 between sprockets 12 of rear drive hub assembly 13, front derailleur 214 serving to alternate chain 11 between front sprockets assembly 15 of front pedals assembly 16, operator command panel 218, how wire anemometer 19, rear derailleur switches 20, front derailleur switches 21, speed sensor 22, seat force sensor 123 and chain movement sensor 124.

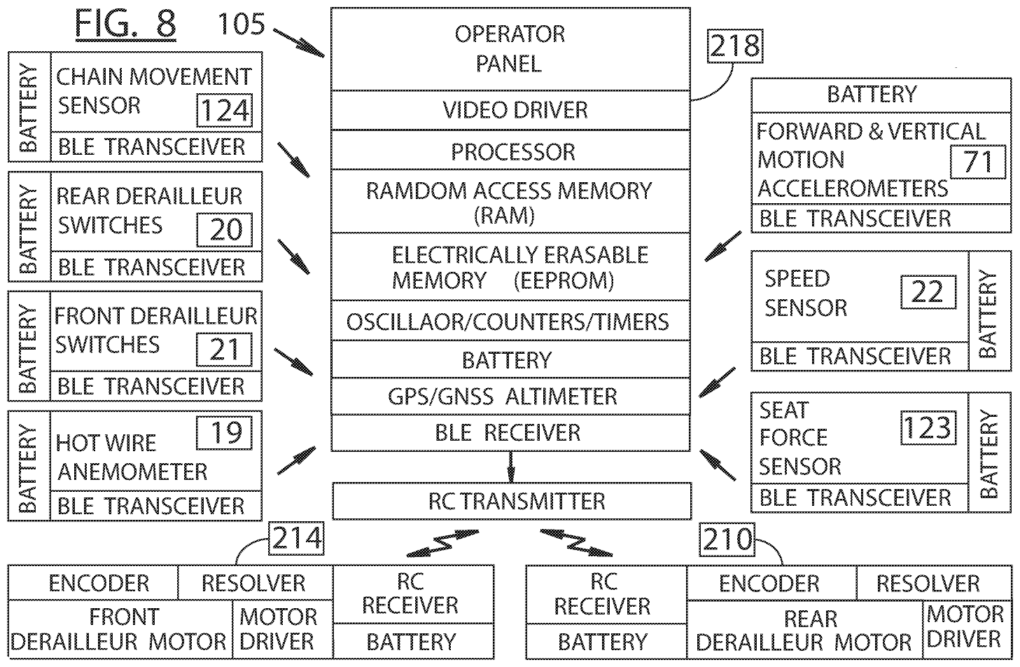

Second Alternate Embodiment Controls—FIG. 8.

With reference to FIG. 8 again, the second alternate embodiment 104 of a bicycle making use of controls block diagram 105 of the alternate embodiment seat force sensor of the present invention comprising control panel 218 acting as a central wireless system controller powered by battery 87, displaying system status and receiving operator commands through touchscreen display 88 based on application program (App) 89, executing on microcontroller subsection 90 including processor 91, video driver 92, random access memory (RAM) 93, electrically erasable programmable read only memory (EEPROM) 94, oscillator/counters/timers subsection 95, based on signals received from integral GPS/GNSS Altimeter 96, and through Bluetooth Low Energy (BLE) transceiver 97 wireless signals received from chain movement sensor 124, seat force sensor 123, speed sensor 22, front derailleur switches 21, rear derailleur switches 20, hot wire anemometer 19, and forward and vertical motion accelerometers 71, serves to wirelessly command each of wireless battery powered front derailleur 214 and wireless battery powered rear derailleur 210 through standard wireless remote control (RC) servo transmitter 98.

Operating as individually powered standard Bluetooth Low Energy (BLE) spectrum protocol discrete transmission units, chain movement sensor 124, seat force sensor 123, speed sensor 22, front derailleur switches 21, rear derailleur switches 20, hot wire anemometer 19, and forward and vertical motion accelerometers 71, each comprising own battery 73 for power and own Bluetooth Low Energy (BLE) transceiver 74, serve to transmit chain movement, seat force, bicycle speed, front and rear derailleur operator commands, wind speed, and forward and vertical accelerations respectively to operator command panel 218 intercepted through BLE transceiver 97 for data processing thereof through APP 89.

Relying on standard wireless remote control (RC) servo receiver 130 serving to receive derailleur position commands from control panel 218, front derailleur 214 additionally comprises, battery 131 serving to provide power and digital magnetic encoder 132 serving to relay actual derailleur position to comparator/resolver 133 used to compare actual derailleur position thereof to desired derailleur position 134 received from control panel 218 and accordingly bias motor driver 135 serving to power electrical motor of front derailleur 214.

Relying on standard wireless remote control (RC) servo receiver 136 serving to receive derailleur position commands from control panel 218, rear derailleur 210 additionally comprises, battery 137 serving to provide power and digital magnetic encoder 138 serving to relay actual derailleur position to comparator/resolver 139 used to compare actual derailleur position thereof to desired derailleur position 140 received from control panel 218 and accordingly bias motor driver 141 serving to power electrical motor of rear derailleur 210.

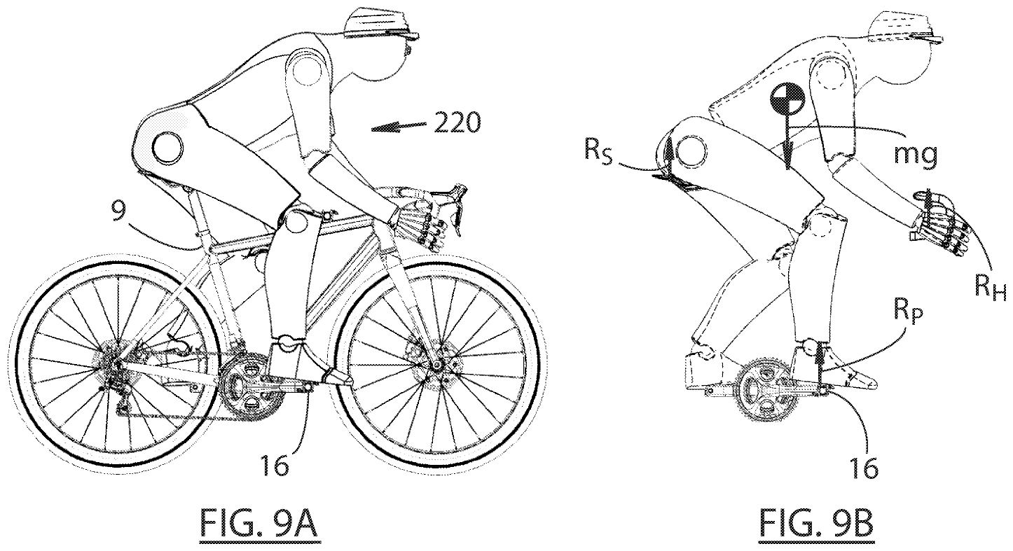

Seat Force Analysis—FIGS. 9A & 9B

With reference to view depicted in FIG. 9A, a snapshot in time of a bicycle rider 220 operating a bicycle is analyzed through a free body diagram (FBD) depicted in FIG. 9B where mass of rider 220 known weight which is mass “m” times gravity “g”=“mg” acting through his centroid results in three reactions, “R_{S}” at the bicycle seat saddle, “R_{P}” at the bicycle pedals and “R_{H}” at the bicycle handlebars. With most riders typically using the handlebars for balancing only through very minute reactions, the relation is reduced to the rider weight being supported by seat reaction “R_{S}” and pedals reaction “R_{P}” resulting in the following equation derived as follows,

Summation of forces in the vertical direction is zero

ΣF_{V}=0

mg=R_{S}+R_{P}+R_{H}

since R_{H}≅0

mg=R_{S}+R_{P}

or

R_{P}=mg−R_{S}

Since the rider weight is known, pedal reaction is directly derived through subtraction thereof of the measured seat force.

It is additionally clear that the seat force is additionally subject to inertial loads due to vibration which typically occurs on rough road surfaces, a condition sensed by the vertical acceleration sensors in control apparatuses depicted in FIGS. 4, 6 and 8, and therefore protected for. It is thereby necessary to ignore seat force readings when this type of condition prevails. Another condition where the readings of the seat force sensor are rendered meaningless is a zero or constant steady state force which would prevail if the operator completely stands off the seat while pedaling the bicycle. In this case the measured seat force is sensed as a zero and therefore also ignored. An additional case arises when the operator stops pedaling resulting in a non-zero steady state force at the seat force sensor which could also be used to sense lack of chain movement.

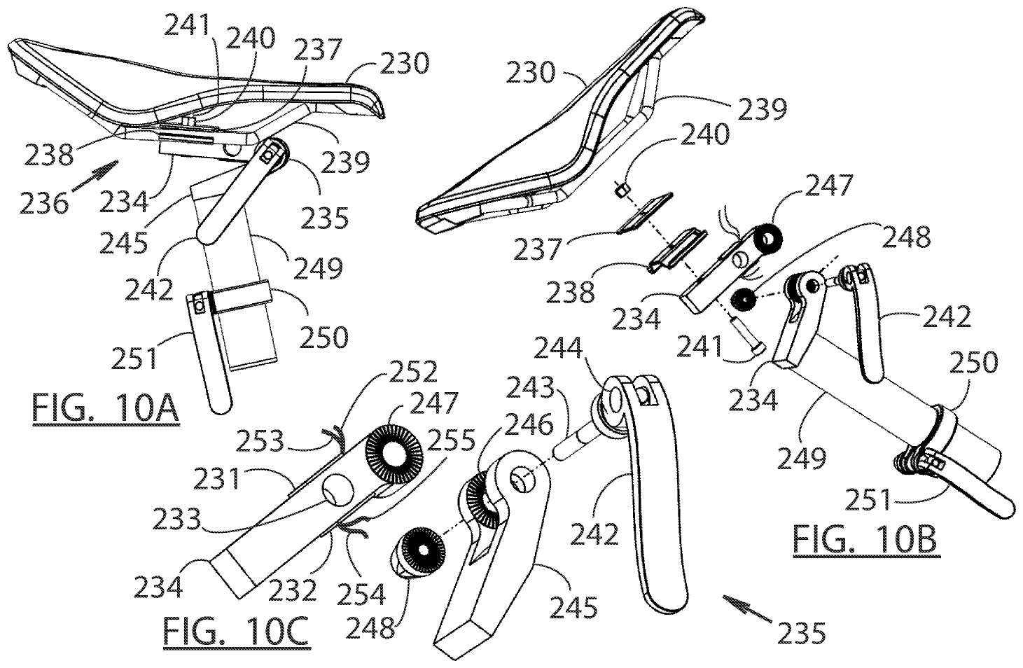

Preferred Seat Force Sensor Construction—FIGS. 10A, 10B & 10C

With reference to FIGS. 10A, 10B & 10C depicting side, exploded and detailed views of the preferred embodiment of the seat force sensor of the present invention, sensing of rider exerted force against bicycle seat saddle 230 is measured in real time through reading of electrical resistance of strain gauge 231 mounted above and strain gauge 232 mounted below of cross hole 233 of cantilever beam 234 rotationally secured in the vertical plane at one end by serrated locking clamp assembly 235, and with bicycle seat clamp assembly 236 comprising upper clamp bracket 237 and lower clamp bracket 238 securing seat shock rails 239 to cantilever beam 234 through tightening of locknut 240 of cantilever beam bolt 241 thereby serving to transmit seat force to end cantilever beam 234 through a finite distance from cross hole 233.

Serrated locking clamp assembly 235 comprising locking handle 242 pivotally secured to tightening screw detail 243 by cross pin 244 serves to collapse forked retainer beam 245 resulting in engagement of thereof serrated interior faces 246 to matching exterior serrated faces 247 of centrally disposed cantilever beam 234 through tightening against locknut 248 thereby rotationally securing cantilever beam 234 and consequentially positioning thereto attached seat saddle 230 in proper angular position through seat clamp assembly 236 with retention of forked retainer beam 245 at other end facilitated through affixation to seat height adjustment tubing 249 with vertical adjustment thereof facilitated by seat height adjustment clamp 250 secured thereof through tightening of clamp handle 251.

Seat force sensing thereof is achieved through reading of resistance variation between terminal 252 and terminal 253 of upper strain gauge 231 and that between terminal 254 and terminal 255 of lower strain gauge 232.

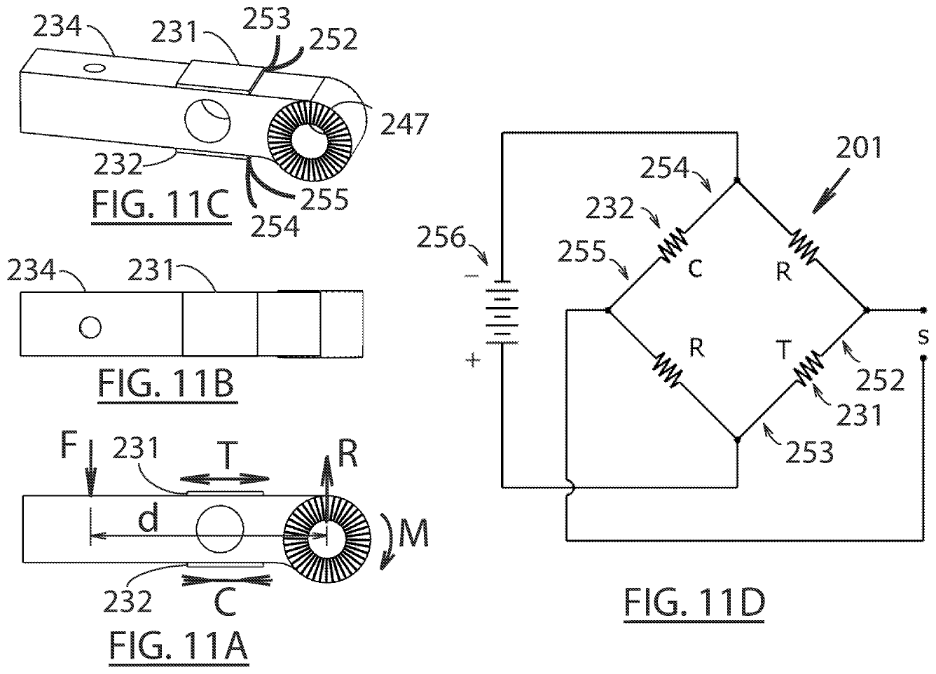

Preferred Seat Force Sensor Operation—FIGS. 11A-11C & 11D

With reference to FIGS. 11B & 11C depicting top and isometric views of cantilever beam 234 and with reference to 11A depicting a free body diagram of loading of cantilever beam 234 in a side view, seat force “F” transmitted to end of cantilever beam 234 through seat clamp assembly 236 counteracted by reaction “R” and moment “M” equal to force “F” acting through distance “d” yields the following statics equations,

Summation of forces in the vertical direction is zero

ΣF_{V}=0

Or

F−R=0

Therefore

F=R

Summation of Moments about center of clamp 235 is zero,

ΣMc=0

Or

M−Fd=0

Therefore

M=Fd

With the net end result being cantilever beam 234 is henceforth subject to bending causing tension “T” in material fibers above cross hole 233 with tension strain thereof sensed by strain gauge 231 and compression “C” in material fibers below cross hole 233 with compression strain thereof sensed by strain gauge 232. Additionally, material strains sensed by strain gauges 231 and 232 due to tension “T” and compression “C” are equalized through central placement of hole 233 in cantilever beam 234.

With reference to FIG. 11D entailing circuitry to sought seat force through measurement of deflection of cantilever beam 234 by means of a Wheatstone Bridge configuration 201 placing strain gauge 231 and strain gauge 232 on opposite legs of the bridge with equal value resistor “R” on each thereof opposing leg. Through introduction of a small voltage differential of battery cells 256 at one of the terminals of each of strain gauges 231 and 232, resultant voltage output “S” proportional to resultant seat force is derived. A notable characteristic of this configuration is inherent compensation for temperature variants causing equal deflections in both of strain gauge 231 and strain gauge 232.

Alternates for implementation of the preferred embodiment of the seat force sensor 23 of the present invention are achieved through direct connection to derailleur control system 17 as depicted in FIG. 4 or implementation thereof in a Bluetooth low energy (BLE) network 123 serving to transmit seat force reading thereof wirelessly as depicted in FIGS. 6 and 8.

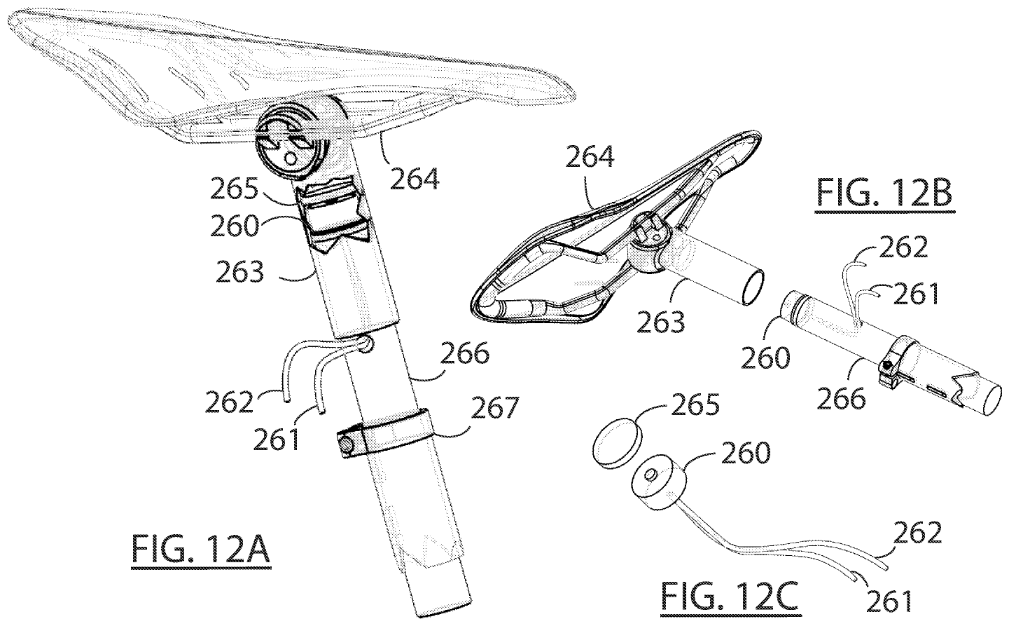

First Alternate Seat Force Sensor Construction—FIGS. 12A-12C

With reference to FIGS. 12A-12C depicting the first alternate embodiment of the seat force sensor of the present invention, seat force measurement is achieved through an apparatus making use of load cell 260 facilitating direct read of seat force through measurement of a parameter variation between load cell terminals 261 and 262. Load cell 260 is additionally confined between a two-piece seat vertical adjustment tubing with upper tube 263 thereof securing seat assembly 264 and with thereto internally affixed bearing plate 265 acting against and therefore serving to transmit resultant seat force directly to load cell 260 affixed to lower tube 266 secured thereof to bicycle frame by clamp 267. Additionally, upper tube 263 slip fits lower tube 266 with substantial engagement thereof serving to take up any torque loading, leading to load cell 260 measuring pure compression reaction due to external force exerted on seat assembly 264.

Alternates for implementation of the first alternate embodiment of the seat force sensor 23 of the present invention are achieved through direct connection to derailleur control system 17 as depicted in FIG. 4 or implementation thereof in a Bluetooth low energy (BLE) network 123 serving to transmit seat force reading thereof wirelessly as depicted in FIGS. 6 and 8.

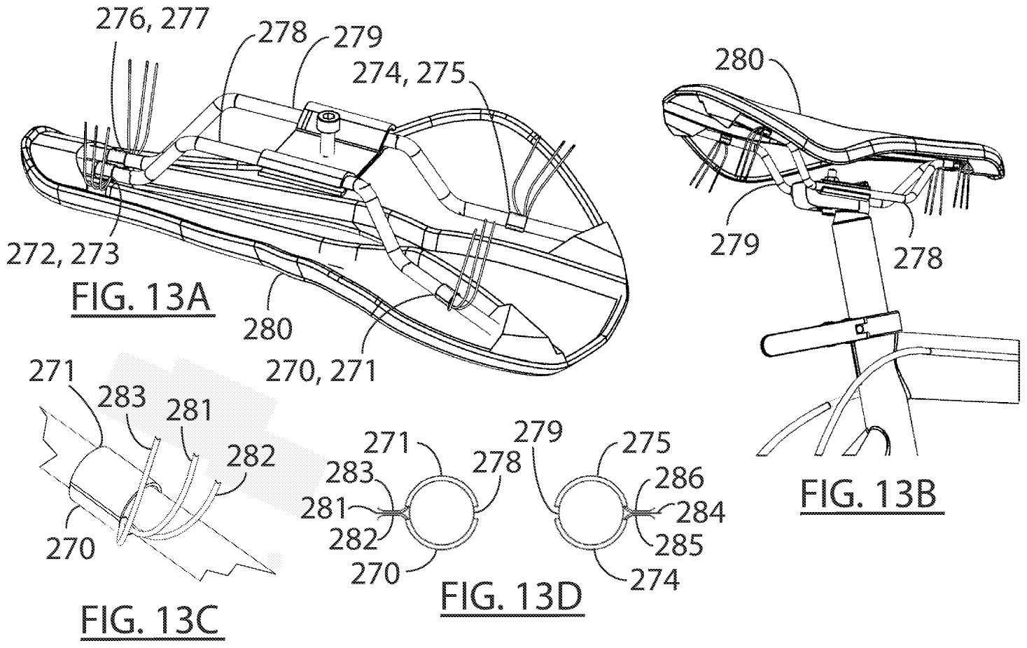

Second Alternate Seat Force Sensor Construction—FIGS. 13A-13D

With reference to FIGS. 13A-13D depicting the second alternate embodiment of the seat force sensor of the present invention, seat force measurement thereof is achieved directly through read of a network of strain gauges affixed to shock rails of bicycle seat saddle. Strain gauge pair right rail rear lower 270 and right rail rear upper 271, pair right rail front lower 272 and right rail front upper 273, pair left rail rear lower 274 and left rail rear upper 275, pair left rail front lower 276 and left rail front upper 277, all attached thereof as called out to right shock rail 278 and left shock rail 279 of seat saddle 280. With reference to FIG. 13D depicting typical strain gauge pair installation, right rear shock rail strain gauges lower 270 and upper 271, and left shock rail strain gauge power 274 and upper 275, with each strain gauge comprising two terminals, two terminals of each train gauge are connected to form a common with remaining two terminals, one to each strain gauge being the output terminals of the pair. As depicted in FIG. 13C for right shock rail rear strain gauges 270 and 271, output wiring consists of common terminal 281 consisting of one terminal of each of lower strain gauge 270 and upper strain gauge 271, lower strain gauge terminal 282 and upper strain gauge terminal 283. Applying to left rear rail resultant terminals are 284 common, 285 lower and 286 upper. Similarly, for right shock rail front strain gauge pair resultant terminals are 287 common, 288 lower and 289 upper. Finally, for left shock rail front strain gauge pair resultant terminals are 290 common, 291 lower and 292 upper.

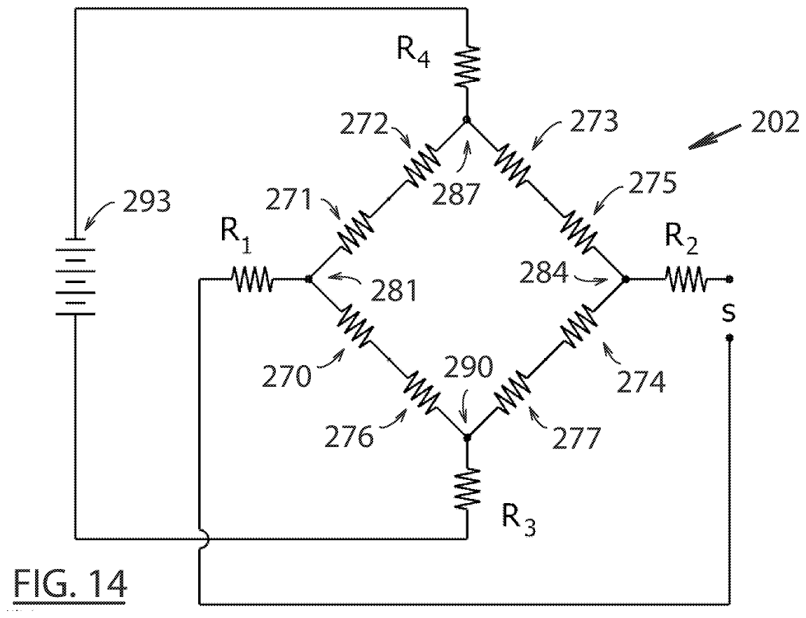

Second Alternate Seat Force Sensor Operation—FIG. 14

With reference to FIG. 14, Wheatstone Bridge network 202 depicting viable interconnection of strain gauges of the second alternate embodiment of the seat force sensor of the present invention, wherein rear right shock rail strain gauge pair 270 and 271 are interconnected in opposing legs to rear left shock rail strain gauge pair 274 and 275, and front right shock rail strain gauge pair 272 and 273 are interconnected in opposing legs to front left shock rail strain gauge pair 276 and 277 with common terminals of each pair, 281, 284, 287 and 290 fed through calibration resistors “R₁”, “R₂”, “R₃” and “R₄” serving to balance output due to any variance in stiffness or geometry thereof, and with a small voltage differential of battery 293 applied to opposite terminals of resistors “R₃” and “R₄” output “S” proportionate to applied force on seat saddle 280 is produced. Similar to Wheatstone Bridge 201 of the preferred embodiment of the seat force sensor of the present invention, automatic temperature compensation is inherent to upper and lower strain gauge pairing of this alternate embodiment due to temperature variants causing equal deflections in both upper and lower of each set of paired strain gauges.

Alternates for implementation of the second alternate embodiment of the seat force sensor 23 of the present invention are achieved through direct connection to derailleur control system 17 as depicted in FIG. 4 or implementation thereof in a Bluetooth low energy (BLE) network 123 serving to transmit seat force reading thereof wirelessly as depicted in FIGS. 6 and 8.

1. A bicycle seat force sensor comprising,
a) a cantilever beam with a retainer to a bicycle frame on one end and a seat mount on opposite end,
b) said cantilever beam further including a first thereto affixed top strain gauge to top surface near said retainer and a second thereto affixed lower strain gauge to lower surface at the same distance thereof from said retainer, and
c) said lower strain gauge is a duplicate of said upper strain gauge,
whereby a vertical force exerted by a rider of a bicycle against said bicycle seat induces bending in said cantilever beam causing tension in said top surface resulting in said upper strain gauge to expand and compression in said lower surface causing said lower strain gauge to contract thereby resulting in resistance signal variances of said upper strain gauge and said lower strain gauge proportionate to said rider vertical force with values of said resistance signal variances thereof diminished in real time proportionately to exerted force by said rider on pedals of said bicycle.

2. The bicycle seat force sensor of claim 1 wherein said cantilever beam further includes a cross hole centrally disposed between said first strain gauge and said second strain gauge.

3. The bicycle seat force sensor of claim 1 wherein said retainer of said cantilever beam further including a bifurcating forward extension with span thereof proportionate to width of said cantilever beam and with a cross hole and thereto aligned internal radial serration.

4. The bicycle seat force sensor of claim 3 wherein said cantilever beam further includes a cross hole and a sideward radial serrations matching said cross hole and said internal serrations of said retainer.

5. The bicycle seat force sensor of claim 4 wherein said cantilever beam is centrally disposed between said bifurcating extensions of said retainer with said bifurcating extensions collapsible about said cantilever beam through a cross bolt and a mating nut.

6. The bicycle seat force sensor of claim 1 wherein said seat mount further including an upper bracket and a lower bracket collapsible about a seat shock rails through a bolt extending through said cantilever beam and a locknut on opposing end.

7. The bicycle seat force sensor of claim 6 wherein said upper bracket and said lower bracket are cylindrically contoured about said seat shock rails with open front and rear ends.

8. The bicycle seat force sensor of claim 1 wherein said upper strain gauge and said lower strain gauge are wired to opposing legs of a Wheatstone bridge circuit.

9. The bicycle seat force sensor of claim 8 wherein said Wheatstone bridge circuit further including two resistors of equal value in opposing legs of said strain gauge legs.

10. A bicycle seat force sensor comprising,
a) a seat vertical adjustment assembly including an upper outer tube with a slip fitting engagement to a lower inner tube,
b) said upper outer tube including a mount for a bicycle seat,
c) said lower inner tube extending through a matching receiving cavity in frame of said bicycle and secured thereto by a compression clamp,
d) said lower inner tube further including a load cell secured to top surface thereof, and
e) said upper outer tube further including an inner bearing plate for stoppage of said slip fitting engagement through contact with said load cell,
whereby a vertical force exerted by a rider of a bicycle against said bicycle seat induces a compression in said load cell producing a signal thereof proportionate to said rider vertical force with value of said produced signal thereof diminished in real time proportionately to exerted force by said rider on pedals of said bicycle.

11. The bicycle seat force sensor of claim 10 wherein terminals of said load cell protrude through a cross hole in said lower inner tube.

12. A bicycle seat force sensor comprising,
a) a seat vertical adjustment assembly including an upper inner tube with a slip fitting engagement to a lower outer tube,
b) said upper inner tube including a mount for a bicycle seat,
c) said lower outer tube extending through a matching receiving cavity in frame of said bicycle and secured thereto by a compression clamp,
d) said upper inner tube further including a load cell secured to bottom surface thereof, and
e) said lower outer tube further including an inner bearing plate for stoppage of said slip fitting engagement through contact with said load cell,
whereby a vertical force exerted by a rider of a bicycle against said bicycle seat induces a compression in said load cell producing a signal thereof proportionate to said rider vertical force with value of said produced signal thereof diminished in real time proportionately to exerted force by said rider on pedals of said bicycle.

13. The bicycle seat force sensor of claim 12 wherein terminals of said load cell protrude through a cross hole in said lower outer tube.

14. A bicycle seat force sensor comprising,
a) a bicycle seat including a saddle supported by a right shock rail, a left shock rail with said right shock rail and said left shock rail centrally supported by a mounting clamp to a seat height adjustment tube,
b) said height adjustment tube further extending though a receiving cavity in frame of a bicycle and secured thereto by a compression clamp,
c) said right shock rail further including an upper rear right shock rail strain gauge and a matching lower rear right shock rail strain gauge in vicinity of rear right shock rail saddle support,
d) said right shock rail further including an upper front right shock rail strain gauge and a matching lower front right shock rail strain gauge in vicinity of front right shock rail saddle support,
e) said left shock rail further including an upper rear left shock rail strain gauge and a matching lower rear left shock rail strain gauge in vicinity of rear left shock rail saddle support, and
f) said left shock rail further including an upper front left shock rail strain gauge and a matching lower front left shock rail strain gauge in vicinity of front left shock rail saddle support,
whereby a vertical force exerted by a rider of a bicycle against said bicycle seat induces bending in said right shock rail resulting in compression in top surface thereof causing contraction of said upper rear right shock rail strain gauge and said upper front right shock rail strain gauge and an equivalent tension in bottom surface thereof causing equivalent expansion in said lower rear right shock rail strain gauge and said lower front right shock rail strain gauge and further bending in said left shock rail resulting in compression in said upper rear left shock rail strain gauge and said upper front left shock rail strain gauge and an equivalent tension in bottom surface thereof causing equivalent expansion in said lower rear left shock rail strain gauge and said lower front left shock rail strain gauge thereby resulting in resistance signal variances of said upper rear right shock rail strain gauge, said lower rear right shock rail strain gauge, said upper front right shock rail strain gauge, said lower front right shock rail strain gauge, said upper rear left shock rail strain gauge, said lower rear left shock rail strain gauge, said upper front left shock rail strain gauge, and said lower front left shock rail strain gauge proportionate to said rider vertical force with value of said produced resistance signal variances thereof diminished in real time proportionately to exerted force by said rider on pedals of said bicycle.

15. The bicycle seat force sensor of claim 14 wherein one terminal of said upper rear right shock rail strain gauge is connected to one terminal of said lower rear right shock rail strain gauge to form a common right rear terminal.

16. The bicycle seat force sensor of claim 15 wherein one terminal of said upper front right shock rail strain gauge is connected to one terminal of said lower front right shock rail strain gauge to form a common right front terminal.

17. The bicycle seat force sensor of claim 16 wherein one terminal of said upper rear left shock rail strain gauge is connected to one terminal of said lower rear left shock rail strain gauge to form a common left rear terminal.

18. The bicycle seat force sensor of claim 17 wherein one terminal of said upper front left shock rail strain gauge is connected to one terminal of said lower front left shock rail strain gauge to form a common left front terminal.

19. The bicycle seat force sensor of claim 18 wherein each of said common right rear terminal, said common right front terminal, said common left rear terminal and said common left front terminal are connected to four legs of a Wheatstone Bridge circuit through calibration balancing resistors.

20. The bicycle seat force sensor of claim 19 wherein said Wheatstone Bridge circuit legs are comprised said lower rear left shock rail strain gauge paired with said lower front left shock rail strain gauge, upper rear left shock rail strain gauge paired with upper front left shock rail strain gauge, lower rear right shock rail strain gauge paired with lower front right shock rail strain gauge, and upper rear right shock rail strain gauge paired with upper front right shock rail strain gauge.

21. The bicycle seat force sensor of claim 20 wherein said Wheatstone Bridge circuit is powered through a pair of said calibration balancing resistors with force output signal available through opposite pair thereof.
